(19) United States
(12) Patent Application Publication
(10) Pub. No.: US 2026/0233448 A1
(43) Pub. Date: Aug. 13, 2026

(54) INJECTION MOLDING DEVICE AND METHOD FOR CONTROLLING INJECTION MOLDING DEVICE

(71) Applicant: SEIKO EPSON CORPORATION, Tokyo (JP)

(72) Inventors: Masashi FUCHII, MINOWA-MACHI (JP); Takayuki SASAKI, MATSUMOTO-SHI (JP); Riona TODA, SHIOJIRI-SHI (JP); Juri YAMAGUCHI, MATSUMOTO-SHI (JP); Miku TAKARA, AZUMINO-SHI (JP); Kenta ANEGAWA, MATSUMOTO-SHI (JP)

(73) Assignee: SEIKO EPSON CORPORATION, Tokyo (JP)

(21) Appl. No.: 19/538,926

(22) Filed: Feb. 12, 2026

(30) Foreign Application Priority Data
Feb. 13, 2025 (JP) 2025-021168

(51) Int. Cl. B29C 45/77; B29C 45/27; B29C 45/74; B29C 45/78

(52) U.S. Cl. CPC B29C 45/77; B29C 45/2725; B29C 45/74; B29C 45/78

(57) ABSTRACT

An injection molding device that performs injection molding of a molded product using a mold formed of a fixed mold and a movable mold, and includes: an injection unit configured to inject a material for the molded product into the mold; a mold opening and closing unit to which the mold is attached and configured to open and close the mold; and a control unit configured to control the injection unit and the mold opening and closing unit. The injection unit includes a material supply portion configured to supply the material, an injection portion communicating with the material supply portion and configured to inject the material into the mold, and a pressure detection portion configured to detect a pressure of the material in the injection portion. The control unit controls the injection portion based on a pressure value included in a first peak waveform detected by the pressure detection portion.

The present application is based on, and claims priority from JP Application Serial Number 2025-021168, filed Feb. 13, 2025, the disclosure of which is hereby incorporated by reference herein in its entirety.

### BACKGROUND

### 1. Technical Field

The present disclosure relates to an injection molding device and a method for controlling an injection molding device.

### 2. Related Art

JP-A-2021-104600 discloses an injection molding machine that executes at least one of a measurement operation and an injection operation based on a detection value detected by a pressure detection portion that detects a pressure of a plasticized material in a communication hole provided between a screw and a nozzle.

JP-A-2021-104600 is an example of the related art.

The waveform of the pressure of the material in an injection portion detected by the pressure detection portion includes various waveforms. However, in JP-A-2021-104600, it is not considered to utilize these waveforms in the control of the injection molding device. In this respect, there is room for improvement.

### SUMMARY

A first aspect of the present disclosure provides an injection molding device that performs injection molding of a molded product using a mold formed of a fixed mold and a movable mold. The injection molding device includes: an injection unit configured to inject a for the molded product into the mold; a mold material opening and closing unit to which the mold is attached and configured to open and close the mold; and a control unit configured to control the injection unit and the mold opening and closing unit. The injection unit includes a material supply portion configured to supply the material, an injection portion communicating with the material supply portion and configured to inject the material into the mold, and a pressure detection portion configured to detect a pressure of the material in the injection portion. A waveform of the pressure detected by the pressure detection portion in an injection period that is a period during which the injection portion performs an injection operation includes a first peak waveform and a second peak waveform that exists after the first peak waveform. The control unit controls the injection portion based on a pressure value included in the first peak waveform.

A second aspect of the present disclosure provides a method for controlling an injection molding device that performs injection molding of a molded product using a mold formed of a fixed mold and a movable mold. The injection molding device includes an injection unit configured to inject a material for the molded product into the mold, and a mold opening and closing unit to which the mold is attached and configured to open and close the mold. The injection unit includes a material supply portion configured to supply the material, an injection portion communicating with the material supply portion and configured to inject the material into the mold, and a pressure detection portion configured to detect a pressure of the material in the injection portion. A waveform of the pressure detected by the pressure detection portion in an injection period that is a period during which the injection portion performs an injection operation includes a first peak waveform and a second peak waveform that exists after the first peak waveform. The method for controlling the injection molding device includes a process of controlling the injection portion based on a pressure value included in the first peak waveform.

### BRIEF DESCRIPTION OF THE DRAWINGS

FIG. 1 illustrates a schematic configuration of an injection molding device.

FIG. 2 is a cross-sectional view illustrating schematic configurations of an injection unit and a mold opening and closing unit.

FIG. 3 is a perspective view illustrating a schematic configuration of a flat screw.

FIG. 4 is a schematic plan view of a barrel.

FIG. 5 is an enlarged view illustrating a range AR in FIG. 2.

FIG. 6 is a view illustrating a structure of an injection portion.

FIG. 7 is a flowchart of an injection molding process.

FIG. 8 is a diagram illustrating an example of a waveform of a pressure detected by a second pressure detection section in an injection period.

FIG. 9 is a flowchart of an injection molding process according to a second embodiment.

FIG. 10 is a flowchart of an injection molding process according to a third embodiment.

FIG. 11 is a flowchart of an injection molding process according to a fourth embodiment.

FIG. 12 is a flowchart of an injection molding process according to a fifth embodiment.

### DESCRIPTION OF EMBODIMENTS

### A. First Embodiment

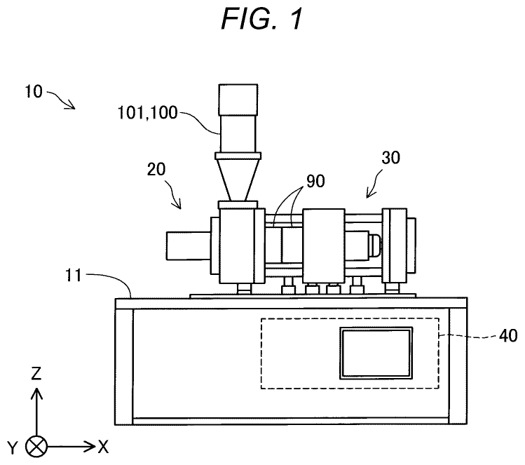

FIG. 1 illustrates a schematic configuration of an injection molding device 10. FIG. 1 shows arrows indicating X, Y, and Z directions orthogonal to one another. The X direction and the Y direction are parallel to a horizontal plane. The Z direction is parallel to a vertical direction. The X, Y, and Z directions in FIG. 1 and the X, Y, and Z directions in the other drawings indicate the same directions. To specify an orientation, a positive or negative sign is added to the description of the direction, where “+” refers to a positive direction that is a direction indicated by an arrow, and “−” refers to a negative direction that is an opposite direction to the direction indicated by the arrow.

The injection molding device 10 includes an injection unit 20, a mold opening and closing unit 30, and a control unit 40. The injection molding device 10 performs injection molding of a molded product using a mold 90 attached to the mold opening and closing unit 30. In the embodiment, the mold 90 made of metal is attached to the mold opening and closing unit 30. The mold 90 attached to the mold opening and closing unit 30 is not limited to being made of metal, and may also be made of resin or ceramic. The mold 90 made of metal is referred to as a metal mold. The injection unit 20 and the mold opening and closing unit 30 are fixed onto a base 11. The control unit 40 is accommodated in the base 11.

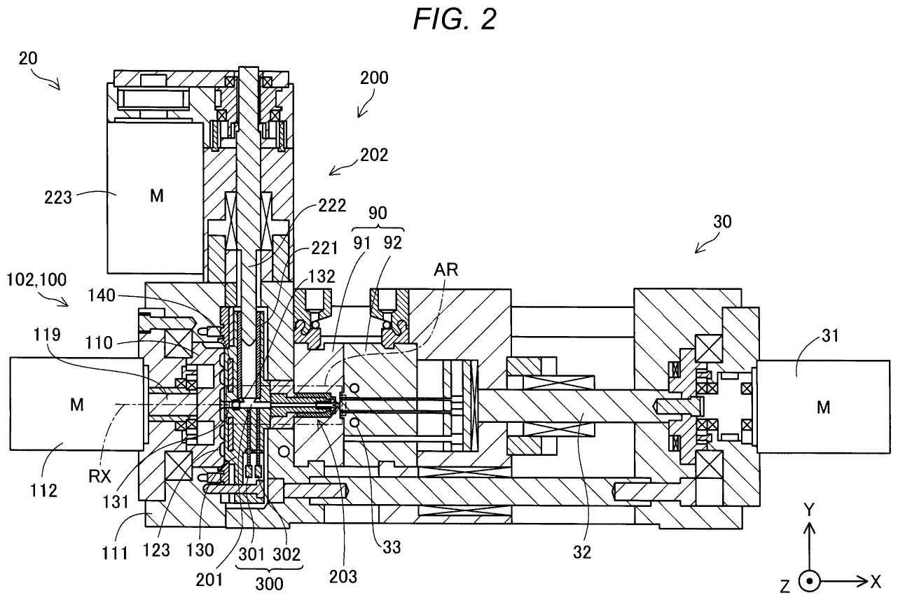

FIG. 2 is a cross-sectional view illustrating schematic configurations of the injection unit 20 and the mold opening and closing unit 30. The injection unit 20 plasticizes at least a part of a material, produces a plasticized material, and injects the produced plasticized material into the mold 90. In the present specification, “plasticizing” has a concept including melting and refers to changing from a solid state to a state having fluidity. Specifically, in a case of a material in which glass transition occurs, plasticizing refers to setting a temperature of the material to a glass transition point or higher. When glass transition does not occur in a material, plasticizing means setting the temperature of the material to a value equal to or higher than the melting point. The injection unit 20 includes a material supply portion 100, an injection portion 200, and a pressure detection portion 300.

The material supply portion 100 supplies the material of a molded product to the injection portion 200. The material supply portion 100 includes a hopper 101 and a plasticizing section 102. The material of a molded product is fed into the hopper 101. An example of the material of a molded product includes a thermoplastic resin formed in a pellet shape. Examples of the thermoplastic resin include acrylonitrile butadiene styrene (ABS), polycarbonate (PC), polyacetal (POM), polypropylene (PP), and polybutylene terephthalate (PBT). The material of a molded product may contain metal or ceramic in addition to the thermoplastic resin.

The plasticizing section 102 plasticizes at least a part of the material supplied from the hopper 101 and produces a plasticized material. The plasticizing section 102 includes a flat screw 110, a barrel 130, and a barrel heater 140.

The flat screw 110 is accommodated in a screw case 111. The flat screw 110 is rotated by a drive motor 112 in the screw case 111 centering on a drive shaft 119 of the drive motor 112. A central axis RX serving as a rotation center of the flat screw 110 coincides with a center of the drive shaft 119 of the drive motor 112 in a YZ plane. In the present embodiment, axial directions of the drive shaft 119 and the central axis RX are along the X direction. Rotation of the flat screw 110 by the drive motor 112 is controlled by the control unit 40. The flat screw 110 may be driven by the drive motor 112 via a decelerator. The flat screw 110 is also referred to as a rotor or simply a screw.

The barrel 130 is formed with, in the center thereof, a communication hole 131 that penetrates the barrel 130 in the X direction. The communication hole 131 forms a part of a flow path 201 through which the plasticized material flows. A cylinder 221 to be described later is coupled to the communication hole 131. The communication hole 131 is provided with a check valve 132 upstream of the cylinder 221. The barrel heater 140 is embedded in the barrel 130. A temperature of the barrel heater 140 is controlled by the control unit 40.

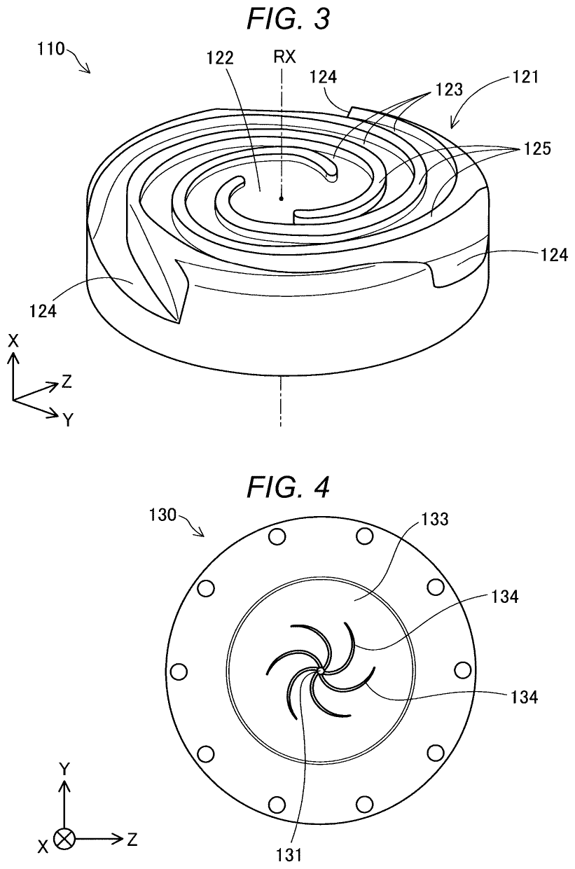

FIG. 3 is a perspective view illustrating a schematic configuration of the flat screw 110. The flat screw 110 has a substantially cylindrical shape in which length in a direction along the central axis RX is smaller than length in a direction perpendicular to the central axis RX. On a groove forming surface 121 of the flat screw 110 that faces the barrel 130, spiral grooves 123 are formed centering on a central portion 122. The grooves 123 communicate with a material inlet 124 formed in a side surface of the flat screw 110. The material supplied from the hopper 101 is supplied to the grooves 123 via the material inlet 124. The grooves 123 are formed by being separated by protruding ridge portions 125. FIG. 3 shows an example in which three grooves 123 are provided, however, the number of grooves 123 may be one or two or more. The grooves 123 are not limited to spirals and may have a helical shape or an involute curve shape, and may also have a shape extending to draw an arc from the central portion 122 toward an outer circumference.

FIG. 4 is a schematic plan view of the barrel 130. The barrel 130 has a facing surface 133 that faces the groove forming surface 121 of the flat screw 110. The communication hole 131 is formed at the center of the facing surface 133. On the facing surface 133, a plurality of guide grooves 134 coupled to the communication hole 131 and extending in a spiral shape from the communication hole 131 toward the outer circumference are formed. The guide grooves 134 may not be provided in the barrel 130. The guide grooves 134 may not be coupled to the communication hole 131.

The material supplied to the grooves 123 of the flat screw 110 is plasticized between the flat screw 110 and the barrel 130 by the rotation of the flat screw 110 and the heating by the barrel heater 140 while flowing along the grooves 123 and the guide grooves 134 by the rotation of the flat screw 110, and is guided to the central portion 122 of the flat screw 110. The material flowed into the central portion 122 flows out to the injection portion 200 from the communication hole 131 formed at the center of the barrel 130.

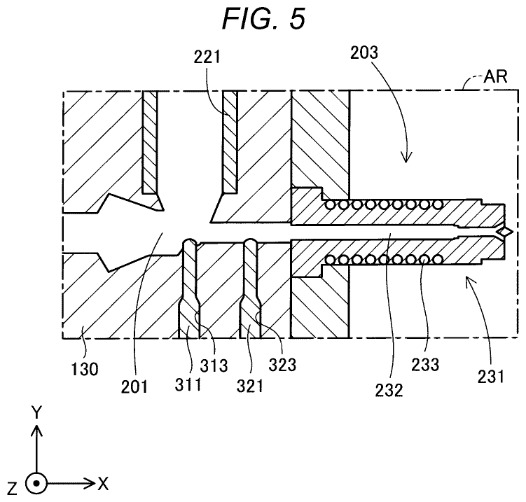

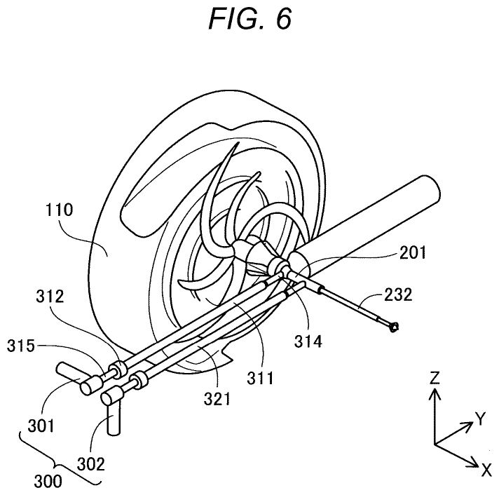

FIG. 5 is an enlarged view illustrating a range AR in FIG. 2. FIG. 6 is a view illustrating a structure of the injection portion 200. FIG. 6 schematically illustrates a shape of a space in the injection unit 20 through which the plasticized material passes when the injection unit 20 injects the plasticized material in addition to the flat screw 110 and the pressure detection portion 300. Specifically, the spaces described above includes the guide grooves 134 of the barrel 130, the flow path 201, an internal space of the cylinder 221, and a nozzle flow path 232 described later. Hereinafter, the injection portion 200 will be described with reference to FIGS. 2, 5, and 6.

The injection portion 200 communicates with the material supply portion 100 and injects the plasticized material supplied from the material supply portion 100 into the mold 90. The injection portion 200 includes the flow path 201 that communicates with the material supply portion 100, a suction delivery section 202, and a hot runner 203.

The suction delivery section 202 includes the cylinder 221, a plunger 222, and a plunger driving unit 223. The suction delivery section 202 controls an injection amount, an injection speed, and an injection pressure of the plasticized material from the hot runner 203 under the control of the control unit 40. The cylinder 221 is a substantially cylindrical member coupled to the flow path 201 and includes the plunger 222 disposed therein. Hereinafter, the position where the cylinder 221 is coupled to the flow path 201 is referred to as a coupling position. In the present embodiment, the cylinder 221 is coupled to the flow path 201 from the +Y direction side. The plunger 222 moves inside the cylinder 221 and pressure-feeds the plasticized material in the cylinder 221 into the hot runner 203. The plunger 222 is driven by the plunger driving unit 223 that includes a motor.

The hot runner 203 guides the plasticized material in a heated state to the mold 90. The hot runner 203 is configured as an open gate type hot runner. The hot runner 203 may be configured as a valve gate type hot runner. The hot runner 203 includes a nozzle portion 231 and a nozzle heater 233.

The nozzle portion 231 has the nozzle flow path 232 that communicates with the flow path 201 and through which the plasticized material flows, and injects the plasticized material.

The nozzle heater 233 heats the plasticized material in the nozzle flow path 232. The nozzle heater 233 is implemented by a coil heater. The nozzle heater 233 is disposed around the nozzle flow path 232 so as to surround the nozzle flow path 232. A temperature of the nozzle heater 233 is controlled by the control unit 40. The molten state of the plasticized material flowing through the nozzle flow path 232 is maintained by the heating of the nozzle heater 233. The nozzle heater 233 is not limited to a coil heater, and may be any heater such as a band heater.

The pressure detection portion 300 includes a first pressure detection section 301 and a second pressure detection section 302. The first pressure detection section 301 detects the pressure of the material in the flow path 201 at the coupling position. The second pressure detection section 302 detects the pressure of the material in the flow path 201 at a position closer to the hot runner 203 than the coupling position.

The first pressure detection section 301 detects the pressure of the plasticized material in the flow path 201 via a first rod 311. The first rod 311 is a shaft-shaped member having a flange portion 312. The first rod 311 is disposed along the Y direction in a first through hole 313 provided in the barrel 130. The first through hole 313 is provided along the Y direction on the −Y direction side of the flow path 201 so as to face the plunger 222. A tip end portion 314, which is one end of the first rod 311, is disposed to face the flow path 201. A rear end portion 315, which is the other end of the first rod 311, is disposed to face the first pressure detection section 301. The flange portion 312 is formed in the middle of the rod in the Y direction. The flange portion 312 is disposed on the −Y direction side of the first through hole 313 so as to restrict the movement of the first rod 311 in the +Y direction.

The tip end portion 314 of the first rod 311 receives pressure from the plasticized material in the flow path 201. The first rod 311 transmits the pressure received by the tip end portion 314 to the first pressure detection section 301 via the rear end portion 315. The first pressure detection section 301 detects the pressure transmitted from the first rod 311.

In the present embodiment, the first pressure detection section 301 is formed by a pressure sensor having quartz crystal. The first pressure detection section 301 detects the pressure received by the first pressure detection section 301 as an electric signal using the piezoelectric effect of the quartz crystal. The first pressure detection section 301 transmits the detected pressure to the control unit 40. The pressure sensor may be formed by a pressure sensor having a piezoelectric element other than the quartz crystal, such as ceramic, or may be formed by a capacitive pressure sensor. In the present embodiment, the pressure detection portion 300 may not include the first pressure detection section 301.

The second pressure detection section 302 detects the pressure of the plasticized material in the flow path 201 via a second rod 321. The second rod 321 is disposed along the Y direction in a second through hole 323 provided in the barrel 130. The second through hole 323 is provided along the Y direction on the −Y direction side of the flow path 201 at a position closer to the hot runner 203 than the plunger 222. That is, the second pressure detection section 302 is provided on the +X direction side of the first pressure detection section 301. The configuration of the second pressure detection section 302 is the same as that of the first pressure detection section 301. The configuration of the second rod 321 is the same as that of the first rod 311. Therefore, the description of the second pressure detection section 302 and the second rod 321 will be omitted. Hereinafter, when the first rod 311 and the second rod 321 are referred to without distinction, they are simply referred to as the rod.

As illustrated in FIG. 2, the mold 90 includes a fixed mold 91 and a movable mold 92. The movable mold 92 is attached to the mold opening and closing unit 30 in a manner of facing the fixed mold 91. The fixed mold 91 is a mold at a fixed position in a mold clamping operation. The movable mold 92 is a mold that is moved relative to the fixed mold 91 in the mold clamping operation. The movable mold 92 is moved in a direction along a mold clamping direction with respect to the fixed mold 91 by the mold opening and closing unit 30. In the present embodiment, the mold clamping direction is a −X direction.

The mold opening and closing unit 30 includes a mold driving portion 31, a ball screw 32, and a mold heating portion 33. The mold driving portion 31 is implemented by a motor, a gear, and the like, and is coupled to the movable mold 92 via the ball screw 32. Drive by the mold driving portion 31 is controlled by the control unit 40. The ball screw 32 transmits power generated by drive of the mold driving portion 31 to the movable mold 92. The mold opening and closing unit 30 opens and closes the mold 90 by moving the movable mold 92 by the mold driving portion 31 and the ball screw 32 under the control of the control unit 40. When the mold 90 is clamped and the fixed mold 91 and the movable mold 92 are brought into contact, a cavity that defines a shape of the molded product is formed between the fixed mold 91 and the movable mold 92. The mold heating portion 33 is a heater that is embedded in the mold 90 and that heats the mold 90. The temperature of the mold heating portion 33 is controlled by the control unit 40.

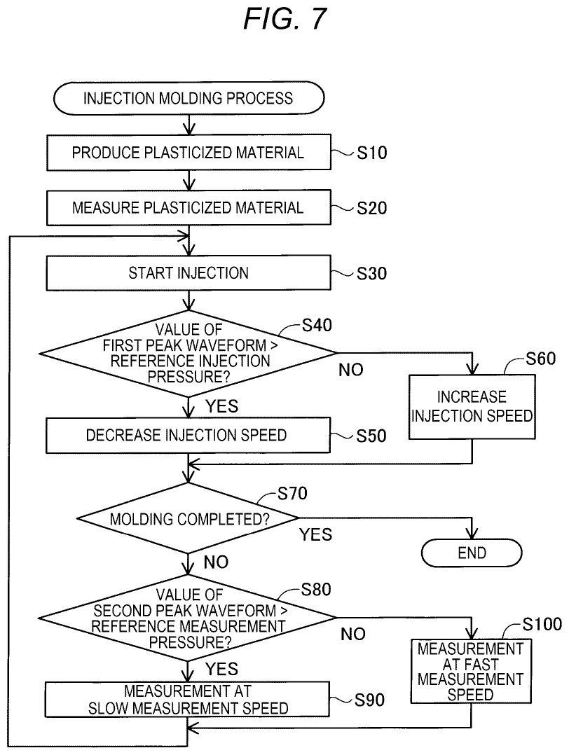

FIG. 7 is a flowchart of an injection molding process. The injection molding process is a process in which the control unit 40 controls the injection unit 20 and the mold opening and closing unit 30 to mold a molded product. By executing the injection molding process, a method for controlling the injection molding device 10 is implemented. During a period in which the injection molding process is being executed, the pressure detection portion 300 continuously detects the pressure of the plasticized material in the flow path 201 and continuously transmits the detected pressure value to the control unit 40.

In step S10, the plasticizing section 102 plasticizes at least a part of the material supplied from the hopper 101 and produces a plasticized material.

In step S20, the control unit 40 controls the plunger driving unit 223 to execute a measurement operation. In the present specification, the measurement operation refers to an operation of guiding the plasticized material into the cylinder 221 by moving the plunger 222 in a direction away from the flow path 201 within the cylinder 221, and measuring the plasticized material in the cylinder 221. Moving the plunger 222 in the direction away from the flow path 201 within the cylinder 221 is also referred to as retracting the plunger 222. The speed at which the plunger 222 moves in the direction away from the flow path 201 within the cylinder 221 is also referred to as a measurement speed. The period during which the measurement operation is executed is also referred to as a measurement period. In step S20, the control unit 40 retracts the plunger 222 at a preset reference measurement speed. Further, the control unit 40 controls the temperature of the mold heating portion 33 to a preset reference mold temperature.

In step S30, the control unit 40 controls the plunger driving unit 223 to start an injection operation. In the present specification, the injection operation refers to an operation of injecting the plasticized material in the cylinder 221 into the mold 90 by moving the plunger 222 in a direction approaching the flow path 201 within the cylinder 221. Moving the plunger 222 in the direction approaching the flow path 201 within the cylinder 221 is also referred to as advancing the plunger 222. The speed at which the plunger 222 moves in the direction approaching the flow path 201 within the cylinder 221 is also referred to as an injection speed. The period during which the injection operation is executed is also referred to as an injection period. In step S30, the control unit 40 starts the advancement of the plunger 222 at a preset reference injection speed.

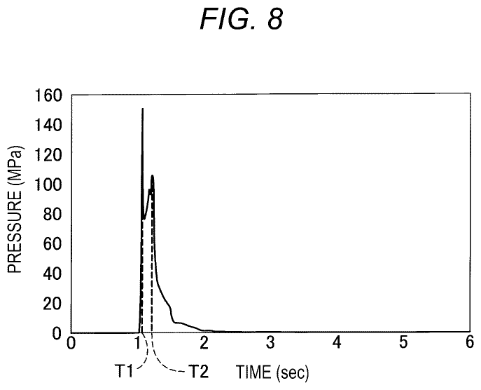

FIG. 8 is a diagram illustrating an example of a waveform of a pressure detected by the second pressure detection section 302 in the injection period. In FIG. 8, the horizontal axis represents elapsed time, and the vertical axis represents pressure detected by the second pressure detection section 302. The waveform of the pressure detected by the second pressure detection section 302 in the injection period includes a first peak waveform and a second peak waveform that exists after the first peak waveform. The first peak waveform is a waveform of the pressure during a period including a peak of the pressure that occurs when the plasticized material begins to flow as the plunger 222 advances. In the example illustrated in FIG. 8, the first peak waveform reaches a maximum pressure at a time point T1. The second peak waveform is a waveform of the pressure during a period including a peak of the pressure that occurs when the filling of the plasticized material into the mold 90 begins. The second peak waveform reaches a maximum pressure at a time point T2. In other words, the first peak waveform is a waveform related to the pressure fluctuation of the plasticized material in the flow path 201 at the beginning of injection. The second peak waveform is a waveform related to the pressure fluctuation of the plasticized material in the flow path 201 at the beginning of filling of the plasticized material into the mold 90.

In step S40 of FIG. 7, the control unit 40 determines whether the pressure value included in the first peak waveform is higher than a preset reference injection pressure. In the present embodiment, the maximum value of pressure values included in the first peak waveform is used as the pressure value included in the first peak waveform. In the example illustrated in FIG. 8, the pressure value at the time point T1 is used as the pressure value included in the first peak waveform. Step S40 is executed between the time point T1 and the time point T2. When the pressure value included in the first peak waveform is higher than the reference injection pressure, step S50 is executed. When the pressure value included in the first peak waveform is equal to or lower than the reference injection pressure, step S60 is executed.

In step S50, the control unit 40 sets the injection speed slower than the reference injection speed. Further, the control unit 40 sets the temperature of the mold heating portion 33 higher than the reference mold temperature. Here, an extent to which the control unit 40 changes the injection speed and the temperature of the mold heating portion 33 is determined by simulation or experiment. The control unit 40 changes the injection speed and the temperature of the mold heating portion 33 based on simulations and experiments so as to produce a molded product of better quality. The control unit 40 may not set the temperature of the mold heating portion 33 higher than the reference mold temperature. The control unit 40 controls the injection speed and the temperature of the mold heating portion 33 during the period from the time point T1 to the time point T2. The control unit 40 may control the injection speed and the temperature of the mold heating portion 33 during the period from the time point T1 to completion of the injection operation. When step S50 is repeatedly executed a plurality of times, the control unit 40 may set the injection speed slower than the injection speed in step S50 executed immediately before. When step S50 is repeatedly executed a plurality of times, the control unit 40 may set the temperature of the mold heating portion 33 higher than the temperature of the mold heating portion 33 in step S50 executed immediately before.

In step S50, the control unit 40 may set a rotation speed of the flat screw 110 slower than a rotation speed before the injection operation is started. The control unit 40 may set the temperature of the barrel heater 140 lower than the temperature before the injection operation is started. The control unit 40 may reduce a supply amount of the material from the hopper 101 to the plasticizing section 102 to be less than a supply amount before the injection operation is started. The control unit 40 may set the temperature of cooling water flowing through a pipe provided in the mold 90 lower than the temperature before the injection operation is started. The control unit 40 may increase a flow rate of the cooling water more than a flow rate before the injection operation is started. Here, an extent to which the control unit 40 changes the rotation speed of the flat screw 110, the temperature of the barrel heater 140, the supply amount of the material, the temperature of the cooling water, and the flow rate of the cooling water is determined by simulations or experiments. The control unit 40 changes above-described values based on simulations and experiments so as to produce a molded product of better quality.

In step S60, the control unit 40 sets the injection speed faster than the reference injection speed. Further, the control unit 40 sets the temperature of the mold heating portion 33 lower than the reference mold temperature. Here, an extent to which the control unit 40 changes the injection speed and the temperature of the mold heating portion 33 is determined by simulation or experiment. The control unit 40 changes the injection speed and the temperature of the mold heating portion 33 based on simulations and experiments so as to produce a molded product of better quality. The control unit 40 may not set the temperature of the mold heating portion 33 lower than the reference mold temperature. The control unit 40 controls the injection speed and the temperature of the mold heating portion 33 during the period from the time point T1 to the time point T2. The control unit 40 may control the injection speed and the temperature of the mold heating portion 33 during the period from the time point T1 to completion of the injection operation. When step S60 is repeatedly executed a plurality of times, the control unit 40 may set the injection speed faster than the injection speed in step S60 executed immediately before. When step S60 is repeatedly executed a plurality of times, the control unit 40 may set the temperature of the mold heating portion 33 lower than the temperature of the mold heating portion 33 in step S60 executed immediately before.

In step S60, the control unit 40 may set the rotation speed of the flat screw 110 faster than the rotation speed before the injection operation is started. The control unit 40 may set the temperature of the barrel heater 140 higher than the temperature before the injection operation is started. The control unit 40 may increase a supply amount of the material from the hopper 101 to the plasticizing section 102 to be greater than a supply amount before the injection operation is started. The control unit 40 may set the temperature of the cooling water flowing through a pipe provided in the mold 90 higher than the temperature before the injection operation is started. The control unit 40 may reduce the flow rate of the cooling water less than the flow rate before the injection operation is started. Here, an extent to which the control unit 40 changes the rotation speed of the flat screw 110, the temperature of the barrel heater 140, the supply amount of the material, the temperature of the cooling water, and the flow rate of the cooling water is determined by simulations or experiments. The control unit 40 changes above-described values based on simulations and experiments so as to produce a molded product of better quality.

In step S70, the control unit 40 determines whether the measurement operation and the injection operation are executed a preset number of times. When the measurement operation and the injection operation are not executed the preset number of times, step S80 is executed. When the measurement operation and the injection operation are executed the preset number of times, the injection molding process is ended. The preset number of times of the measurement operation and the injection operation is two or more.

In step S80, the control unit 40 determines whether the pressure value included in the second peak waveform is higher than a preset reference measurement pressure. In the present embodiment, the maximum value of pressure values included in the second peak waveform is used as the pressure value included in the second peak waveform. In the example illustrated in FIG. 8, the pressure value at the time point T2 is used as the pressure value included in the second peak waveform. When the pressure value included in the second peak waveform is higher than the reference measurement pressure, step S90 is executed. When the pressure value included in the second peak waveform is equal to or lower than the reference measurement pressure, step S100 is executed.

In step S90, the control unit 40 controls the plunger driving unit 223 to execute the measurement operation at a measurement speed slower than the reference measurement speed. Further, the control unit 40 sets the temperature of the mold heating portion 33 higher than the reference mold temperature. Here, an extent to which the control unit 40 changes the injection speed and the temperature of the mold heating portion 33 is determined by simulation or experiment. The control unit 40 changes the injection speed and the temperature of the mold heating portion 33 based on simulations and experiments so as to produce a molded product of better quality. The control unit 40 may not execute the measurement operation at a measurement speed slower than the reference measurement speed. Further, the control unit 40 may not set the temperature of the mold heating portion 33 higher than the reference mold temperature. That is, the control unit 40 may control at least one of the measurement speed and the temperature of the mold heating portion 33 in the measurement period based on the pressure value included in the second peak waveform. When step S90 is repeatedly executed a plurality of times, the control unit 40 may execute the measurement operation at a measurement speed slower than a measurement speed in step S90 executed immediately before. Further, when step S90 is repeatedly executed a plurality of times, the control unit 40 may set the temperature of the mold heating portion 33 higher than the temperature of the mold heating portion 33 in step S90 executed immediately before.

In step S90, the control unit 40 may set a rotation speed of the flat screw 110 slower than a rotation speed before the measurement operation is started. The control unit 40 may set the temperature of the barrel heater 140 lower than the temperature before the measurement operation is started. The control unit 40 may reduce a supply amount of the material from the hopper 101 to the plasticizing section 102 to be less than a supply amount before the measurement operation is started. The control unit 40 may set the temperature of cooling water flowing through a pipe provided in the mold 90 lower than the temperature before the measurement operation is started. The control unit 40 may increase a flow rate of the cooling water more than a flow rate before the measurement operation is started. Here, an extent to which the control unit 40 changes the rotation speed of the flat screw 110, the temperature of the barrel heater 140, the supply amount of the material, the temperature of the cooling water, and the flow rate of the cooling water is determined by simulations or experiments. The control unit 40 changes above-described values based on simulations and experiments so as to produce a molded product of better quality.

In step S100, the control unit 40 controls the plunger driving unit 223 to execute the measurement operation at a measurement speed faster than the reference measurement speed. Further, the control unit 40 sets the temperature of the mold heating portion 33 lower than the reference mold temperature. Here, an extent to which the control unit 40 changes the injection speed and the temperature of the mold heating portion 33 is determined by simulation or experiment. The control unit 40 changes the injection speed and the temperature of the mold heating portion 33 based on simulations and experiments so as to produce a molded product of better quality. The control unit 40 may not execute the measurement operation at a measurement speed faster than the reference measurement speed. Further, the control unit 40 may not set the temperature of the mold heating portion 33 lower than the reference mold temperature. That is, the control unit 40 may control at least one of the measurement speed and the temperature of the mold heating portion 33 in the measurement period based on the pressure value included in the second peak waveform. When step S100 is repeatedly executed a plurality of times, the control unit 40 may execute the measurement operation at a measurement speed higher than a measurement speed in step S100 executed immediately before. Further, when step S100 is repeatedly executed a plurality of times, the control unit 40 may set the temperature of the mold heating portion 33 higher than the temperature of the mold heating portion 33 in step S100 executed immediately before.

In step S100, the control unit 40 may set a rotation speed of the flat screw 110 faster than a rotation speed before the measurement operation is started. The control unit 40 may set the temperature of the barrel heater 140 higher than the temperature before the measurement operation is started. The control unit 40 may increase a supply amount of the material from the hopper 101 to the plasticizing section 102 to be greater than a supply amount before the measurement operation is started. The control unit 40 may set the temperature of cooling water flowing through a pipe provided in the mold 90 higher than the temperature before the measurement operation is started. The control unit 40 may reduce a flow rate of the cooling water less than a flow rate before the measurement operation is started. Here, an extent to which the control unit 40 changes the rotation speed of the flat screw 110, the temperature of the barrel heater 140, the supply amount of the material, the temperature of the cooling water, and the flow rate of the cooling water is determined by simulations or experiments. The control unit 40 changes above-described values based on simulations and experiments so as to produce a molded product of better quality. After step S90 or step S100 is executed, the process returns to step S30. As described above, the injection molding process is executed.

According to the first embodiment described above, the waveform of the pressure detected by the second pressure detection section 302 in the injection period, which is the period during which the injection portion 200 performs the injection operation, includes the first peak waveform and the second peak waveform that exists after the first peak waveform, and the control unit 40 controls the injection portion 200 based on the pressure value included in the first peak waveform. The first peak waveform is a waveform related to the pressure fluctuation of the plasticized material in the flow path 201 at the beginning of injection. Therefore, by the control unit 40 controlling the injection portion 200 based on the pressure value included in the first peak waveform, the injection accuracy of the plasticized material can be improved, and the quality of the molded product can be improved. Further, in controlling the injection molding device 10, the waveform of the pressure of the plasticized material in the injection portion 200 can be utilized.

In the present embodiment, the control unit 40 controls the mold heating portion 33 based on the pressure value included in the second peak waveform. The second peak waveform is a waveform related to the pressure fluctuation of the plasticized material in the flow path 201 at the beginning of filling of the plasticized material into the mold 90. The pressure value included in the second peak waveform varies depending on the difficulty of filling the mold 90 with the plasticized material. Therefore, the control unit 40 controls the mold heating portion 33 based on the pressure value included in the second peak waveform, so that the accuracy of filling the plasticized material into the mold 90 can be improved, and the quality of the molded product can be improved.

In the present embodiment, the control unit 40 controls the injection speed during the injection period based on the pressure value included in the first peak waveform. Therefore, the injection accuracy of the plasticized material can be improved, and the quality of the molded product can be improved.

In the present embodiment, the control unit 40 controls the temperature of the mold heating portion 33 during the injection period based on the pressure value included in the first peak waveform. Therefore, the injection accuracy of the plasticized material can be improved, and the quality of the molded product can be improved.

In the present embodiment, the control unit 40 controls at least one of the measurement speed and the temperature of the mold heating portion 33 during the measurement period, which is a period during which the injection portion 200 performs the measurement operation after the injection period, based on the pressure value included in the second peak waveform. Therefore, the accuracy of filling the plasticized material into the mold 90 can be improved, and the quality of the molded product can be improved.

In the present embodiment, the injection portion 200 includes the flow path 201, the cylinder 221, the plunger 222, and the hot runner 203. The hot runner 203 includes the nozzle portion 231 that has the nozzle flow path 232 that communicates with the flow path 201 and through which the plasticized material flows, and that injects the plasticized material, and the nozzle heater 233 that heats the plasticized material in the nozzle flow path 232. The pressure detection portion 300 detects the pressure of the plasticized material in the flow path 201. Therefore, the pressure of the plasticized material in the injection portion 200 can be detected with high accuracy. Therefore, it is possible to improve the accuracy of the control of the injection portion 200 based on the pressure value included in the first peak waveform or the pressure value included in the second peak waveform.

In the present embodiment, the second pressure detection section 302 detects the pressure of the material in the flow path 201 at a position closer to the hot runner 203 than the coupling position where the cylinder 221 is coupled to the flow path 201. Therefore, the pressure of the plasticized material in the flow path 201 can be detected with high accuracy. Therefore, it is possible to improve the accuracy of the control of the injection portion 200 based on the pressure value included in the first peak waveform or the pressure value included in the second peak waveform.

### B. Second Embodiment

The second embodiment is different from the first embodiment in contents of the injection molding process. Configurations of the injection molding device 10 according to the second embodiment are the same as those in the first embodiment.

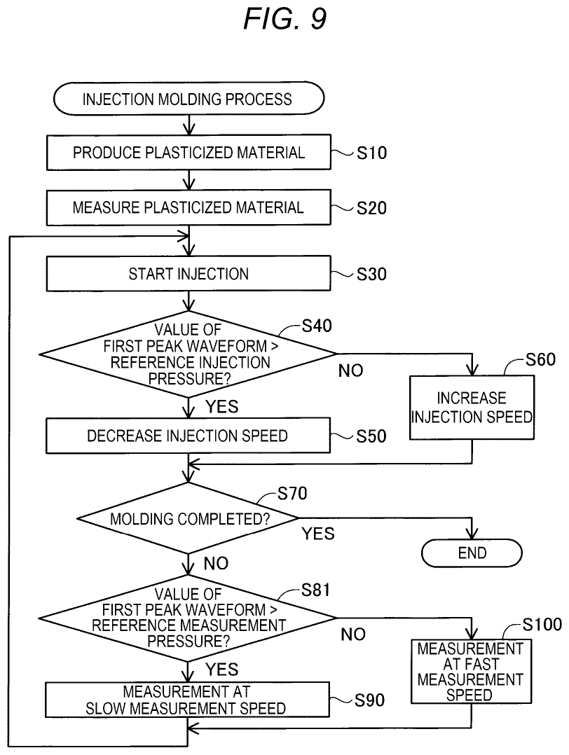

FIG. 9 is a flowchart of the injection molding process according to the second embodiment. For a part in which a process similar to that in the injection molding process in the first embodiment is executed, the same reference numerals are given and description thereof will be omitted.

In step S81, the control unit 40 determines whether the pressure value included in the first peak waveform is higher than a reference measurement pressure. In the present embodiment, the maximum value of pressure values included in the first peak waveform is used as the pressure value included in the first peak waveform. When the pressure value included in the first peak waveform is higher than the reference measurement pressure, step S90 is executed. When the pressure value included in the first peak waveform is equal to or lower than the reference measurement pressure, step S100 is executed. That is, the control unit 40 controls at least one of the measurement speed and the temperature of the mold heating portion 33 in the measurement period based on the pressure value included in the first peak waveform.

According to the second embodiment described above, the control unit 40 controls at least one of the measurement speed and the temperature of the mold heating portion 33 during the measurement period, which is a period during which the injection portion 200 performs the measurement operation after the injection period, based on the pressure value included in the first peak waveform. Therefore, the injection accuracy of the plasticized material can be improved, and the quality of the molded product can be improved.

### C. Third Embodiment

The third embodiment is different from the first embodiment in contents of the injection molding process. Configurations of the injection molding device 10 according to the third embodiment are the same as those in the first embodiment.

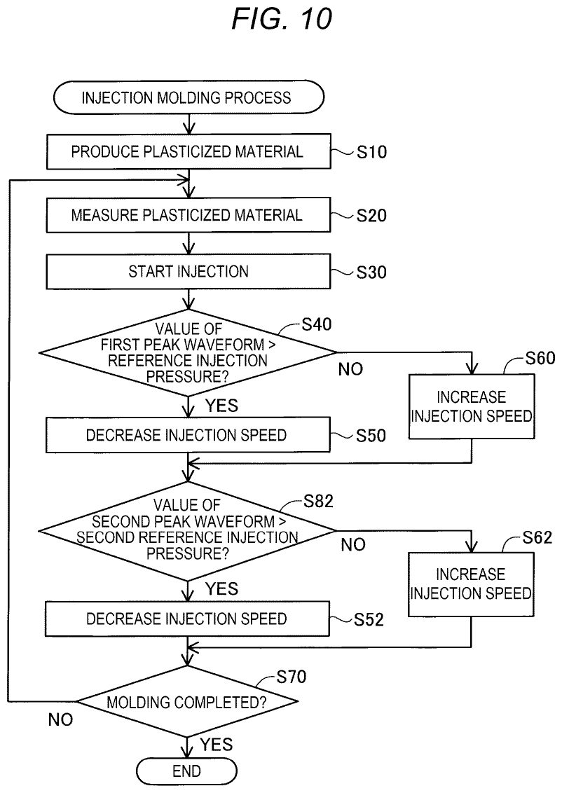

FIG. 10 is a flowchart of an injection molding process according to the third embodiment. For a part in which a process similar to that in the injection molding process in the first embodiment is executed, the same reference numerals are given and description thereof will be omitted.

In the third embodiment, step S82 is executed after step S50 or step S60 is executed. In steps S50 and S60, the control unit 40 controls the injection speed and the temperature of the mold heating portion 33 during the period from the time point T1 to the time point T2.

In step S82, the control unit 40 determines whether the pressure value included in the second peak waveform is higher than a preset second reference injection pressure. Here, the second reference injection pressure is a value smaller than the reference injection pressure. In the present embodiment, the maximum value of pressure values included in the second peak waveform is used as the pressure value included in the second peak waveform. When the pressure value included in the second peak waveform is higher than the second reference injection pressure, step S52 is executed. When the pressure value included in the second peak waveform is equal to or lower than the second reference injection pressure, step S62 is executed. The second reference injection pressure may be a value equal to or higher than the reference injection pressure.

In step S52, the control unit 40 sets the injection speed slower than the injection speed set in step S50 or step S60, and sets the temperature of the mold heating portion 33 higher than the temperature set in step S50 or step S60. Here, an extent to which the control unit 40 changes the injection speed and the temperature of the mold heating portion 33 is determined by simulation or experiment. The control unit 40 changes the injection speed and the temperature of the mold heating portion 33 based on simulations and experiments so as to produce a molded product of better quality. The control unit 40 controls the injection speed and the temperature of the mold heating portion 33 during the period from the time point T2 to completion of the injection operation. The control unit 40 may not set the injection speed slower than the injection speed set in step S50 or step S60. The control unit 40 may not set the temperature of the mold heating portion 33 higher than the temperature set in step S50 or step S60. That is, the control unit 40 may control at least one of the injection speed and the temperature of the mold heating portion 33 in the injection period based on the pressure value included in the second peak waveform. When step S52 is repeatedly executed a plurality of times, the control unit 40 may set the injection speed slower than the injection speed in step S52 executed immediately before. Further, when step S52 is repeatedly executed a plurality of times, the control unit 40 may set the temperature of the mold heating portion 33 higher than the temperature of the mold heating portion 33 in step S52 executed immediately before.

In step S52, the control unit 40 may set the rotation speed of the flat screw 110 slower than the rotation speed set in step S50 or step S60. The control unit 40 may set the temperature of the barrel heater 140 lower than the temperature set in step S50 or step S60. The control unit 40 may set the supply amount of the material from the hopper 101 to the plasticizing section 102 smaller than the supply amount set in step S50 or step S60. The control unit 40 may set the temperature of the cooling water flowing through a pipe provided in the mold 90 lower than the temperature set in step S50 or step S60. The control unit 40 may increase the flow rate of the cooling water more than the flow rate set in step S50 or step S60. Here, an extent to which the control unit 40 changes the rotation speed of the flat screw 110, the temperature of the barrel heater 140, the supply amount of the material, the temperature of the cooling water, and the flow rate of the cooling water is determined by simulations or experiments. The control unit 40 changes above-described values based on simulations and experiments so as to produce a molded product of better quality.

In step S62, the control unit 40 sets the injection speed faster than the injection speed set in step S50 or step S60, and sets the temperature of the mold heating portion 33 lower than the temperature set in step S50 or step S60. Here, an extent to which the control unit 40 changes the injection speed and the temperature of the mold heating portion 33 is determined by simulation or experiment. The control unit 40 changes the injection speed and the temperature of the mold heating portion 33 based on simulations and experiments so as to produce a molded product of better quality. The control unit 40 controls the injection speed and the temperature of the mold heating portion 33 during the period from the time point T2 to completion of the injection operation. The control unit 40 may not set the injection speed faster than the injection speed set in step S50 or step S60. The control unit 40 may not set the temperature of the mold heating portion 33 lower than the temperature set in step S50 or step S60. That is, the control unit 40 may control at least one of the injection speed and the temperature of the mold heating portion 33 in the injection period based on the pressure value included in the second peak waveform. When step S62 is repeatedly executed a plurality of times, the control unit 40 may set the injection speed faster than the injection speed in step S62 executed immediately before. Further, when step S62 is repeatedly executed a plurality of times, the control unit 40 may set the temperature of the mold heating portion 33 lower than the temperature of the mold heating portion 33 in step S62 executed immediately before.

In step S62, the control unit 40 may set the rotation speed of the flat screw 110 slower than the rotation speed set in step S50 or step S60. The control unit 40 may set the temperature of the barrel heater 140 lower than the temperature set in step S50 or step S60. The control unit 40 may set the supply amount of the material from the hopper 101 to the plasticizing section 102 smaller than the supply amount set in step S50 or step S60. The control unit 40 may set the temperature of the cooling water flowing through a pipe provided in the mold 90 lower than the temperature set in step S50 or step S60. The control unit 40 may increase the flow rate of the cooling water more than the flow rate set in step S50 or step S60. Here, an extent to which the control unit 40 changes the rotation speed of the flat screw 110, the temperature of the barrel heater 140, the supply amount of the material, the temperature of the cooling water, and the flow rate of the cooling water is determined by simulations or experiments. The control unit 40 changes above-described values based on simulations and experiments so as to produce a molded product of better quality.

After step S52 or step S62 is executed, step S70 is executed. In step S70, when the measurement operation and the injection operation are not executed a preset number of times, the process returns to step S20. When the measurement operation and the injection operation are executed the preset number of times, the injection molding process is ended.

According to the third embodiment described above, the control unit 40 controls at least one of the injection speed and the temperature of the mold heating portion 33 in the injection period based on the pressure value included in the second peak waveform. Therefore, the injection accuracy of the plasticized material can be improved, and the quality of the molded product can be improved.

### D. Fourth Embodiment

The fourth embodiment is different from the first embodiment in contents of the injection molding process. Configurations of the injection molding device 10 according to the fourth embodiment are the same as those in the first embodiment.

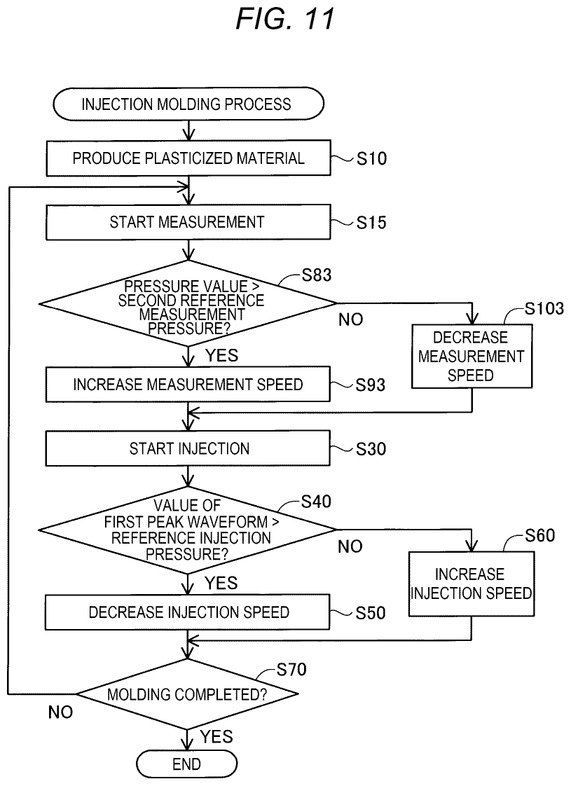

FIG. 11 is a flowchart of an injection molding process according to the fourth embodiment. For a part in which a process similar to that in the injection molding process in the first embodiment is executed, the same reference numerals are given and description thereof will be omitted.

In step S15, the control unit 40 starts the measurement operation. The control unit 40 starts the retraction of the plunger 222 at a reference measurement speed. After step S15 is executed, step S83 is executed.

In step S83, the control unit 40 determines whether a pressure value detected by the first pressure detection section 301 in the measurement period is higher than a preset second reference measurement pressure. Here, the second reference measurement pressure is a value different from the reference measurement pressure. When the pressure value detected by the first pressure detection section 301 is higher than the second reference measurement pressure, step S93 is executed. When the pressure value detected by the first pressure detection section 301 is equal to or less than the second reference measurement pressure, step S103 is executed.

In step S93, the control unit 40 sets the measurement speed faster than the reference measurement speed. That is, the control unit 40 controls the measurement speed during the measurement period based on the pressure value detected by the pressure detection portion 300 in the measurement period.

In step S103, the control unit 40 sets the measurement speed slower than the reference measurement speed. That is, the control unit 40 controls the measurement speed during the measurement period based on the pressure value detected by the pressure detection portion 300 in the measurement period. Step S83, step S93, and step S103 may be repeatedly executed many times during the measurement period. After step S93 or step S103 is executed, step S30 is executed.

According to the fourth embodiment described above, the control unit 40 controls the measurement speed based on the pressure value detected by the pressure detection portion 300 in the measurement period. The density of the plasticized material in the flow path 201 in the measurement period decreases as the measurement speed increases, and increases as the measurement speed decreases. The weight of the plasticized material injected from the nozzle portion 231 increases as the pressure of the plasticized material in the flow path 201 during the measurement period increases, and decreases as the pressure of the plasticized material in the flow path 201 during the measurement period decreases. Therefore, the density of the plasticized material in the flow path 201 during the measurement period can be controlled by controlling the measurement speed based on the pressure of the plasticized material in the flow path 201 during the measurement period. Therefore, the density of the plasticized material in the flow path 201 during the measurement period can be stabilized, and the quality of the molded product can be improved.

### E. Fifth Embodiment

The fifth embodiment is different from the first embodiment in contents of the injection molding process. Configurations of the injection molding device 10 according to the fifth embodiment are the same as those in the first embodiment.

The control unit 40 calculates the viscosity of the material in the flow path 201 using Equation (1), and controls the injection portion 200 based on the calculated viscosity.

$$η = ( π \times PL \times {d}^{4} ) / ( 128 \times L \times Q ) \qquad ( 1 )$$

In Equation (1), PL is a pressure value included in the first peak, d is a diameter of the nozzle flow path 232, L is a length of the nozzle flow path 232, and Q is a volume flow rate ratio. In the present embodiment, d is the diameter of the cross section of the nozzle flow path 232 in the YZ plane, and L is the length of the nozzle flow path 232 in the X direction. The volume flow rate ratio is the product of a cross-sectional area of the plunger 222 and a moving speed of the plunger 222. Here, the moving speed of the plunger 222 is the injection speed.

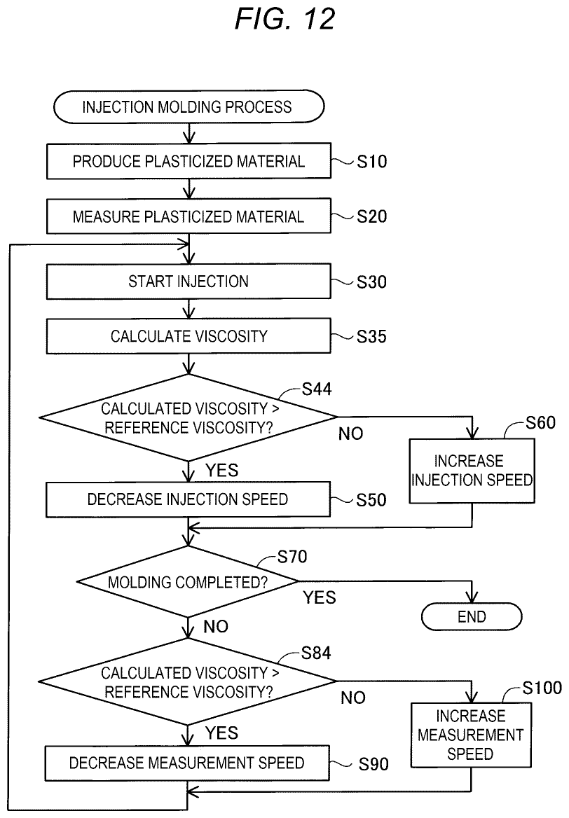

FIG. 12 is a flowchart of an injection molding process according to the fifth embodiment. For a part in which a process similar to that in the injection molding process in the first embodiment is executed, the same reference numerals are given and description thereof will be omitted.

In step S35, the control unit 40 calculates the viscosity of the plasticized material in the flow path 201 using Equation (1). When calculating the viscosity, the control unit 40 uses the maximum value of the pressure values included in the first peak waveform as the value of PL.

In step S44, the control unit 40 determines whether the viscosity calculated in step S35 is greater than a preset reference viscosity. When the viscosity calculated in step S35 is greater than the reference viscosity, step S50 is executed. That is, when the calculated viscosity is greater than the reference viscosity, the control unit 40 sets the injection speed slower than the reference injection speed. When the viscosity calculated in step S35 is equal to or less than the reference viscosity, step S60 is executed. That is, when the calculated viscosity is smaller than the reference viscosity, the control unit 40 sets the injection speed faster than the reference injection speed.

In step S84, the control unit 40 determines whether the viscosity calculated in step S35 is greater than the reference viscosity. When the viscosity calculated in step S35 is greater than the reference viscosity, step S90 is executed. That is, when the calculated viscosity is greater than the reference viscosity, the control unit 40 sets the measurement speed slower than the reference measurement speed. When the viscosity calculated in step S35 is equal to or less than the reference viscosity, step S100 is executed. That is, when the calculated viscosity is equal to or less than the reference viscosity, the control unit 40 sets the measurement speed faster than the reference measurement speed.

According to the fifth embodiment described above, the control unit 40 calculates the viscosity of the material in the flow path 201 using Equation (1) described above, and controls the injection portion 200 based on the calculated viscosity. Therefore, the injection accuracy of the plasticized material can be improved, and the quality of the molded product can be improved.

In the present embodiment, the control unit 40 sets the injection speed slower than the reference injection speed when the viscosity is greater than the reference viscosity, and sets the injection speed faster than the reference injection speed when the viscosity is equal to or less than the reference viscosity. Therefore, the injection accuracy of the plasticized material can be improved, and the quality of the molded product can be improved.

In the present embodiment, the control unit 40 sets the measurement speed slower than the reference measurement speed when the viscosity is greater than the reference viscosity, and sets the measurement speed faster than the reference measurement speed when the viscosity is equal to or less than the reference viscosity. Therefore, the injection accuracy of the plasticized material can be improved, and the quality of the molded product can be improved.

### F. Other Embodiments

(F-1) In the first embodiment, the control unit 40 controls at least one of the measurement speed and the temperature of the mold heating portion 33 during the measurement period, which is a period during which the injection portion 200 performs the measurement operation after the injection period, based on the pressure value included in the second peak waveform. In this regard, in the first embodiment, the control unit 40 may not control either one of the measurement speed and the temperature of the mold heating portion 33 during the measurement period, which is a period during which the injection portion 200 performs the measurement operation after the injection period, based on the pressure value included in the second peak waveform. That is, the control unit 40 may not control the mold heating portion 33 based on the pressure value included in the second peak waveform. That is, in the injection molding process in the first embodiment, step S80, step S90, and step S100 may not be executed.
(F-2) In the fifth embodiment, the control unit 40 controls the injection speed based on the viscosity of the plasticized material in the flow path 201 calculated using Equation (1). In this regard, the control unit 40 may not control the injection speed based on the viscosity of the plasticized material in the flow path 201 calculated using Equation (1). That is, in the injection molding process in the fifth embodiment, step S44, step S50, and step S60 may not be executed.
(F-3) In the fifth embodiment, the control unit 40 controls the measurement speed based on the viscosity of the plasticized material in the flow path 201 calculated using Equation (1). In this regard, the control unit 40 may not control the measurement speed based on the viscosity of the plasticized material in the flow path 201 calculated using Equation (1). That is, in the injection molding process in the fifth embodiment, step S84, step S90, and step S100 may not be executed. In this case, the control unit 40 retracts the plunger 222 at the reference measurement speed to execute the measurement operation.
(F-4) In the embodiments described above, the injection portion 200 includes the hot runner 203. In this regard, in the first embodiment to the fourth embodiment, the injection portion 200 may only have the nozzle portion 231 that communicates with the flow path 201 and injects the plasticized material, and may not have the hot runner 203.
(F-5) In the embodiments described above, the maximum value of pressure values included in the first peak waveform is used as the pressure value included in the first peak waveform. In this regard, the average value of pressure values included in the first peak waveform may be used as the pressure value included in the first peak waveform.
(F-6) In the embodiments described above, the maximum value of pressure values included in the second peak waveform is used as the pressure value included in the second peak waveform. In this regard, the average value of pressure values included in the second peak waveform may be used as the pressure value included in the second peak waveform.
(F-7) In the embodiments described above, the pressure detection portion 300 includes the first pressure detection section 301 and the second pressure detection section 302. In this regard, the pressure detection portion 300 may include only the first pressure detection section 301, or may include only the second pressure detection section 302. The pressure detection portion 300 may detect the pressure of the plasticized material in the cylinder 221 instead of the pressure of the plasticized material in the flow path 201.
(F-8) In the embodiments described above, the pressure detection portion 300 detects the pressure of the plasticized material in the flow path 201 via the rod. In this regard, the pressure detection portion 300 may detect the pressure of the plasticized material in the flow path 201 without using the rod.

### G. Other Configurations

The present disclosure is not limited to the above embodiment, and can be implemented in various forms without departing from the scope of the present disclosure. For example, the present disclosure may also be implemented in the following aspects. The technical features in the above embodiment corresponding to the technical features in the aspects described below can be replaced or combined as appropriate in order to solve a part or all of the problems of the present disclosure, or to achieve a part or all of the advantages of the present disclosure. Also, any of the technical features can be deleted as appropriate unless described as essential in the present specification.
(1) A first aspect of the present disclosure provides an injection molding device that performs injection molding of a molded product using a mold formed of a fixed mold and a movable mold. The injection molding device includes: an injection unit configured to inject a material for the molded product into the mold; a mold opening and closing unit to which the mold is attached and configured to open and close the mold; and a control unit configured to control the injection unit and the mold opening and closing unit. The injection unit includes a material supply portion configured to supply the material, an injection portion communicating with the material supply portion and configured to inject the material into the mold, and a pressure detection portion configured to detect a pressure of the material in the injection portion. A waveform of the pressure detected by the pressure detection portion in an injection period that is a period during which the injection portion performs an injection operation includes a first peak waveform and a second peak waveform that exists after the first peak waveform. The control unit controls the injection portion based on a pressure value included in the first peak waveform.

The first peak waveform is a waveform related to the pressure fluctuation of the material in the injection portion at the beginning of injection. According to such an aspect, the injection accuracy of the material can be improved, and the quality of the molded product can be improved.
(2) In the above aspect, the mold opening and closing unit may include a mold heating portion configured to heat the mold, and the control unit may control the mold heating portion based on a pressure value included in the second peak waveform.

The pressure value included in the second peak waveform varies depending on the difficulty of filling the mold with the material. According to such an aspect, the filling accuracy of the material into the mold can be improved, and the quality of the molded product can be improved.
(3) In the above aspect, the injection portion may include a flow path communicating with the material supply portion and through which the material flows, a cylinder coupled to the flow path, a plunger disposed in the cylinder and configured to move in the cylinder, and a nozzle portion communicating with the flow path and configured to inject the material.
(4) In the above aspect, the control unit may control a speed at which the plunger is moved in a direction approaching the flow path during the injection period based on a pressure value included in the first peak waveform.

According to such an aspect, the injection accuracy of the material can be improved, and the quality of the molded product can be improved.
(5) In the above aspect, the control unit may control a temperature of the mold heating portion during the injection period based on a pressure value included in the first peak waveform.

According to such an aspect, the injection accuracy of the material can be improved, and the quality of the molded product can be improved.
(6) In the above aspect, the mold opening and closing unit may include a mold heating portion configured to heat the mold, and the control unit may control, based on a pressure value included in the first peak waveform, at least one of a speed at which the plunger is moved in a direction away from the flow path and a temperature of the mold heating portion in a measurement period that is a period during which the injection portion performs a measurement operation after the injection period.

According to such an aspect, the injection accuracy of the material can be improved, and the quality of the molded product can be improved.
(7) In the above aspect, the mold opening and closing unit may include a mold heating portion configured to heat the mold, and the control unit may control at least one of a speed at which the plunger is moved in a direction approaching the flow path and a temperature of the mold heating portion in the injection period based on a pressure value included in the second peak waveform.

According to such an aspect, the filling accuracy of the plasticized material into the mold can be improved, and the quality of the molded product can be improved.
(8) In the above aspect, the mold opening and closing unit may include a mold heating portion configured to heat the mold, and the control unit may control, based on a pressure value included in the second peak waveform, at least one of a speed at which the plunger is moved in a direction away from the flow path and a temperature of the mold heating portion in a measurement period that is a period during which the injection portion performs a measurement operation after the injection period.

According to such an aspect, the injection accuracy of the material can be improved, and the quality of the molded product can be improved.
(9) In the above aspect, the injection portion may include a flow path communicating with the material supply portion and through which the material flows, a cylinder coupled to the flow path, a plunger disposed in the cylinder and configured to move in the cylinder, and a hot runner. The hot runner may include a nozzle portion having a nozzle flow path that communicates with the flow path and through which the material flows, and configured to inject the material, and a nozzle heater configured to heat the material in the nozzle flow path. The pressure detection portion may detect a pressure of the material in the flow path.

According to such an aspect, since the pressure of the material in the injection portion can be accurately detected, the accuracy of the control on the injection portion can be improved based on the pressure value included in the first peak waveform.
(10) In the above aspect, the pressure detection portion may detect a pressure of the material in the flow path at a position closer to the hot runner than a coupling position where the cylinder is coupled to the flow path.

According to such an aspect, since the pressure of the material in the flow path can be accurately detected, the accuracy of the control on the injection portion can be improved based on the pressure value included in the first peak waveform.
(11) In the above aspect, the control unit may calculate viscosity of the material in the flow path using Equation (1) below, and controls the injection portion based on the calculated viscosity,

$$η = ( π \times PL \times {d}^{4} ) / ( 128 \times L \times Q ) \qquad ( 1 )$$

PL is a pressure value included in the first peak waveform, d is a diameter of the nozzle flow path, L is a length of the nozzle flow path, and Q is a product of a cross-sectional area of the plunger and a moving speed of the plunger.

According to such an aspect, the injection accuracy of the material can be improved, and the quality of the molded product can be improved.
(12) In the above aspect, the control unit may set a speed at which the plunger is moved in a direction approaching the flow path slower than a reference injection speed when the viscosity is greater than reference viscosity, and may set the speed at which the plunger is moved in the direction approaching the flow path faster than the reference injection speed when the viscosity is equal to or less than the reference viscosity.

According to such an aspect, the injection accuracy of the material can be improved, and the quality of the molded product can be improved.
(13) In the above aspect, the control unit may set a speed at which the plunger is moved in a direction away from the flow path slower than a reference measurement speed when the viscosity is greater than reference viscosity, and may set the speed at which the plunger is moved in the direction away from the flow path faster than the reference measurement speed when the viscosity is equal to or less than the reference viscosity.

According to such an aspect, the injection accuracy of the material can be improved, and the quality of the molded product can be improved.
(14) A second aspect of the present disclosure provides a method for controlling an injection molding device that performs injection molding of a molded product using a mold formed of a fixed mold and a movable mold. The injection molding device includes an injection unit configured to inject a material for the molded product into the mold, and a mold opening and closing unit to which the mold is attached and configured to open and close the mold. The injection unit includes a material supply portion configured to supply the material, an injection portion communicating with the material supply portion and configured to inject the material into the mold, and a pressure detection portion configured to detect a pressure of the material in the injection portion. A waveform of the pressure detected by the pressure detection portion in an injection period that is a period during which the injection portion performs an injection operation includes a first peak waveform and a second peak waveform that exists after the first peak waveform. The method for controlling the injection molding device includes a process of controlling the injection portion based on a pressure value included in the first peak waveform.

The first peak waveform is a waveform related to the pressure fluctuation of the material in the injection portion at the beginning of injection. According to such an aspect, the injection accuracy of the material can be improved, and the quality of the molded product can be improved.

What is claimed is:

1. An injection molding device that performs injection molding of a molded product using a mold formed of a fixed mold and a movable mold, the injection molding device comprising:
an injection unit configured to inject a material for the molded product into the mold;
a mold opening and closing unit to which the mold is attached and configured to open and close the mold; and
a control unit configured to control the injection unit and the mold opening and closing unit, wherein
the injection unit includes
a material supply portion configured to supply the material,
an injection portion communicating with the material supply portion and configured to inject the material into the mold, and
a pressure detection portion configured to detect a pressure of the material in the injection portion,
a waveform of the pressure detected by the pressure detection portion in an injection period that is a period during which the injection portion performs an injection operation includes a first peak waveform and a second peak waveform that exists after the first peak waveform, and
the control unit controls the injection portion based on a pressure value included in the first peak waveform.

2. The injection molding device according to claim 1, wherein
the mold opening and closing unit includes a mold heating portion configured to heat the mold, and
the control unit controls the mold heating portion based on a pressure value included in the second peak waveform.

3. The injection molding device according to claim 1, wherein
the injection portion includes
a flow path communicating with the material supply portion and through which the material flows,
a cylinder coupled to the flow path,
a plunger disposed in the cylinder and configured to move in the cylinder, and
a nozzle portion communicating with the flow path and configured to inject the material.

4. The injection molding device according to claim 3, wherein
the control unit controls a speed at which the plunger is moved in a direction approaching the flow path during the injection period based on a pressure value included in the first peak waveform.

5. The injection molding device according to claim 4, wherein
the mold opening and closing unit includes a mold heating portion configured to heat the mold, and
the control unit controls a temperature of the mold heating portion during the injection period based on a pressure value included in the first peak waveform.

6. The injection molding device according to claim 3, wherein
the mold opening and closing unit includes a mold heating portion configured to heat the mold, and
the control unit controls, based on a pressure value included in the first peak waveform, at least one of a speed at which the plunger is moved in a direction away from the flow path and a temperature of the mold heating portion in a measurement period that is a period during which the injection portion performs a measurement operation after the injection period.

7. The injection molding device according to claim 3, wherein
the mold opening and closing unit includes a mold heating portion configured to heat the mold, and
the control unit controls at least one of a speed at which the plunger is moved in a direction approaching the flow path and a temperature of the mold heating portion in the injection period based on a pressure value included in the second peak waveform.

8. The injection molding device according to claim 3, wherein
the mold opening and closing unit includes a mold heating portion configured to heat the mold, and
the control unit controls, based on a pressure value included in the second peak waveform, at least one of a speed at which the plunger is moved in a direction away from the flow path and a temperature of the mold heating portion in a measurement period that is a period during which the injection portion performs a measurement operation after the injection period.

9. The injection molding device according to claim 1, wherein
the injection portion includes a flow path communicating with the material supply portion and through which the material flows,
a cylinder coupled to the flow path,
a plunger disposed in the cylinder and configured to move in the cylinder, and
a hot runner, wherein
the hot runner includes
a nozzle portion having a nozzle flow path that communicates with the flow path and through which the material flows, and configured to inject the material, and
a nozzle heater configured to heat the material in the nozzle flow path, and
the pressure detection portion detects a pressure of the material in the flow path.

10. The injection molding device according to claim 9, wherein
the pressure detection portion detects a pressure of the material in the flow path at a position closer to the hot runner than a coupling position where the cylinder is coupled to the flow path.

11. The injection molding device according to claim 9, wherein
the control unit calculates viscosity of the material in the flow path using Equation (1) below, and controls the injection portion based on the calculated viscosity,
η=(π×PL×d⁴)/(128×L×Q) (1)
in which PL is a pressure value included in the first peak waveform, d is a diameter of the nozzle flow path, L is a length of the nozzle flow path, and Q is a product of a cross-sectional area of the plunger and a moving speed of the plunger.

12. The injection molding device according to claim 11, wherein
the control unit is configured to
set a speed at which the plunger is moved in a direction approaching the flow path slower than a reference injection speed when the viscosity is greater than reference viscosity, and
set the speed at which the plunger is moved in the direction approaching the flow path faster than the reference injection speed when the viscosity is equal to or less than the reference viscosity.

13. The injection molding device according to claim 11, wherein
the control unit is configured to
set a speed at which the plunger is moved in a direction away from the flow path slower than a reference measurement speed when the viscosity is greater than reference viscosity, and
set the speed at which the plunger is moved in the direction away from the flow path faster than the reference measurement speed when the viscosity is equal to or less than the reference viscosity.

14. A method for controlling an injection molding device that performs injection molding of a molded product using a mold formed of a fixed mold and a movable mold,
the injection molding device including
an injection unit configured to inject a material for the molded product into the mold, and
a mold opening and closing unit to which the mold is attached and configured to open and close the mold,
the injection unit including
a material supply portion configured to supply the material,
an injection portion communicating with the material supply portion and configured to inject the material into the mold, and
a pressure detection portion configured to detect a pressure of the material in the injection portion,
a waveform of the pressure detected by the pressure detection portion in an injection period that is a period during which the injection portion performs an injection operation including a first peak waveform and a second peak waveform that exists after the first peak waveform,
the method comprising:
a process of controlling the injection portion based on a pressure value included in the first peak waveform.
